(19) United States
(12) Patent Application Publication
(10) Pub. No.: US 2023/0250003 A1
(43) Pub. Date: Aug. 10, 2023

(54) Water Filtration System, and Associated Method

(71) Applicant: Cloud Water Filter, LLC, San Diego, CA (US)

(72) Inventors: Douglas Marsden, Marblehead, MA (US); Andrew A. Panasyuk, Somerville, MA (US); Michael McDuffee, Gloucester, MA (US); Marc Halliwell Senger, Plymouth, MA (US); Benjamin J. Beck, Boston, MA (US)

(21) Appl. No.: 18/166,865

(22) Filed: Feb. 9, 2023

Related U.S. Application Data
(60) Provisional application No. 63/308,322, filed on Feb. 9, 2022.

(51) Int. Cl. C02F 9/00; C02F 1/00; B01D 61/02; B01D 61/04; B01D 61/08; B01D 61/12

(52) U.S. Cl. CPC C02F 9/00; C02F 1/008; B01D 61/025; B01D 61/04; B01D 61/081; B01D 61/12; C02F 2201/007; C02F 2201/006; C02F 2201/005; C02F 2209/03; C02F 2209/10; C02F 2201/009; C02F 1/441

(57) ABSTRACT

In an embodiment, a modular water filtration system includes a magazine and a base. The magazine includes a plurality of cartridge receptacles, a magazine input water valve, and a magazine output valve, where a first cartridge receptacle is coupled between the magazine input water valve and the magazine output valve. The base includes a first fitting configured to receive input water, a second fitting configured to provide drinking water, a base input water valve configured to be coupled to the magazine input water valve, a first solenoid valve having a water path coupled between the first fitting and the base input water valve, a base first valve configured to be coupled to the magazine output valve, and a first switch.

### CROSS-REFERENCE TO RELATED APPLICATIONS

This application claims the benefit of U.S. Provisional Application No. 63/308,322, filed on Feb. 9, 2022, which application is hereby incorporated herein by reference.

### TECHNICAL FIELD

The present disclosure relates generally to an electronic system and method, and, in particular embodiments, to a water filtration system, and associated method.

### BACKGROUND

Water may contain impurities that affect the water quality, e.g., for drinking purposes. A water filter removes impurities using mechanical, chemical, and/or biological processes. A drinking water filtration system for home use, may include one or more stages utilizing different processes for improving the quality of water for human consumption. For example, FIG. 1 shows a block diagrams of exemplary reverse osmosis (RO) filtration systems 100. RO filtration system 100 includes sediment filtration stage 102, carbon filtration stage 104, RO filtration stage 106, and post-filter stage 108.

Sediment filtration stage 102 generally includes a physical membrane for removing impurities, such as dirt, rust, and suspended particles.

Carbon filtration stage 104 generally includes a carbon substrate that removes impurities such as chlorine, volatile organic compounds (VOCs) by adsorption. The carbon filtration stage 104 may also help in protecting the RO membrane of the RO filtration stage 106.

RO filtration stage 106 generally includes an RO membrane that separate ions, unwanted molecules, and large particles from drinking water. For example, RO filtration stage 104 may remove fluoride, lead, arsenic, and other minerals from the drinking water. The removed impurities are discarded as wastewater, e.g., into the drain.

Post-filter stage 108 may include a post-carbon media and a remineralization media. The post-carbon media of stage 108 may remove residual chlorine, and other remaining organic particles and may enhance the taste of the filtered water. The remineralization media of stage 108 generally introduces back into the drinking water minerals that are beneficial for human consumption, such as calcium, magnesium, sodium, potassium, etc. The output of the remineralization stage is, e.g., delivered to a faucet.

When system 100 is implemented without the remineralization media and is operating properly, filtered water (e.g., at the output of stages 102, 104, 106 or 108) has less impurities than the input water. Impurities in water may be measured using a total dissolved solids (TDS) sensor in ways known in the art and may be reported in TDS ppm. Thus, when system boo is operating properly, the filtered water has less TDS ppm than the input water.

When system 100 is implemented with the remineralization media, the water at the output of stage 108 may have higher TDS ppm than the water at the input of stage 108.

Stages 102, 104, 106, and 108 are generally implemented as cartridges that can be attached or detached (e.g., for replacement purposes) from the filtration system.

FIG. 2 shows a block diagrams of exemplary RO filtration systems 200. RO filtration system 200 operates in a similar manner as RO filtration system 100. RO filtration system 200, however, includes water storage tank 202 for storing drinking water.

RO filtration systems without a water storage tank (such as RO filtration system 100) may require a booster pump for pushing water through the filtration stages and thus may need to be powered by mains. RO filtration systems with a water storage tank (such as RO filtration system 200) may operate using the water pressure from the input water to fill the water storage tank 202, and thus may advantageously avoid being powered by mains.

RO filtration systems such as 100 and 200 may be intended to be used under the sink.

FIG. 3 shows additional details of exemplary 4-stage under-the-sink RO system 200. As shown in FIG. 3, a housing 302 receives input water and provides drinking water. Stages 1-4 are screwed into housing 302. Housing 302 includes water tubing for routing water into and out of the water filter stages (e.g., 102, 104, 106, 108) and water storage tank 202. Housing 302 is generally attached to a wall/panel in a cabinet under the kitchen sink.

The process of replacing water filters (e.g., 102, 104, 106, and 108) involves: turning off the input water, removing the water filter to be replaced by unscrewing the water filter from housing 302, screwing the new water filter into housing 302, and turning on the input water.

RO system 200 operates using the water pressure, does not include any electronics, and is not powered by mains.

### SUMMARY

In accordance with an embodiment, a modular water filtration system includes: a magazine including: a plurality of cartridge receptacles for a plurality of cartridges, where a first cartridge receptacle of the plurality of cartridge receptacles is configured to receive a water filter cartridge, a magazine input water valve, and a magazine output valve, where the first cartridge receptacle is coupled between the magazine input water valve and the magazine output valve; and a base including: a first fitting configured to receive input water, a second fitting configured to provide drinking water, a base input water valve configured to be coupled to the magazine input water valve, a first solenoid valve having a water path coupled between the first fitting and the base input water valve, a base first valve configured to be coupled to the magazine output valve, and a first switch, where the base is configured to detach from the magazine and cause the first solenoid valve to close when the first switch transitions from a first state to a second state.

In accordance with an embodiment, a base configured to be attached to a magazine of a water filtration system. The base includes a first fitting configured to receive input water, a second fitting configured to provide drinking water with less impurities than the input water, a base input water valve configured to be coupled to a magazine input water valve of the magazine, a first solenoid valve having a water path coupled between the first fitting and the base input water valve, a base first valve configured to be coupled to a magazine output valve of the magazine, and a first switch, where the base is configured to detach from the magazine and cause the first solenoid valve to close when the first switch transitions from a first state to a second state, and where the base does not include a water filter or water filter receptacle.

In accordance with an embodiment, a method for operating a water filtration system including receiving an input water with a first fitting; providing drinking water with a second fitting, the drinking water having less impurities than the input water; transitioning a first switch from a first state to a second state; in response to the first switch transitioning from the first state to the second state, closing a first solenoid valve having a water path coupled to the first fitting, the first solenoid valve being inside a housing of the water filtration system; after closing the first solenoid valve, replacing a water filter of the water filtration system without turning off the input water; and after replacing the water filter, opening the first solenoid valve.

In accordance with an embodiment, a method for preventing water leakage from a water filtration system. The method includes receiving input water with a first fitting of a base of the water filtration system; providing drinking water with a second fitting of the base, the drinking water having less impurities than the input water; transitioning a first switch from a first state to a second state to detach a magazine from the base, the magazine including a water filter that receives the input water from the base and provides filter water to the base, the drinking water being based on the filtered water; and in response to the first switch transitioning from the first state to the second state, closing a first solenoid valve having a water path coupled to the first fitting or to the second fitting, the first solenoid valve being inside a housing of the base.

In accordance with an embodiment, a method for preserving power in a water filtration system. The method includes receiving input water with a first fitting; providing drinking water with a second fitting, the drinking water having less impurities than the input water; when the water filtration system is in an active state, sensing a quality of water inside the water filtration system using a sensor to produce sensor data, collecting the sensor data using a control circuit, and transmitting information based on the sense data using a communication interface circuit of the control circuit; when the water filtration system in in a low-power state, turning off or into a low power state the communication interface circuit, where the water filtration system is powered from a battery, where an active power consumption from the battery during the active state is higher than a low-power power consumption from the battery during the low-power state; detecting water flow out of the second fitting using a flow switch; when water is not flowing out of the second fitting, entering the low-power state; and when water begins to flow out of the second fitting, transition from the low-power state to the active state.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1-3 show block diagrams of exemplary RO filtration systems;

FIG. 4A shows a front top perspective view of an RO filtration system, according to an embodiment of the present invention;

FIG. 4B shows a front top view of an RO filtration system, according to an embodiment of the present invention;

FIG. 4C shows a front top perspective view of an RO filtration system, according to an embodiment of the present invention;

FIG. 5A shows a rear top view of an RO filtration system, according to an embodiment of the present invention;

FIG. 5B shows a rear top view of an RO filtration system, according to an embodiment of the present invention;

FIG. 6A shows a rear bottom view of an RO filtration system, according to an embodiment of the present invention;

FIG. 6B shows a front bottom view of an RO filtration system, according to an embodiment of the present invention;

FIG. 7 shows a schematic diagram the RO filtration system of, e.g., FIGS. 4A-6B, according to an embodiment of the present invention;

FIG. 8 shows a flow chart of an embodiment method for installing, operating, and maintaining the RO filtration system of FIGS. 4A-7, according to an embodiment of the present invention;

FIG. 9 shows an electrical schematic of a possible implementation of the control circuit of FIG. 7, according to an embodiment of the present invention;

FIG. 10 shows a state diagram of a state machine of the control circuit of FIG. 7, according to an embodiment of the present invention;

FIG. 11 shows a flow chart of an embodiment method for determining when to close the latching solenoid valves of FIG. 7, according to an embodiment of the present invention;

FIGS. 12A and 12B show the RO filtration system of FIGS. 4A-4C with the lever engaged and not engaged, respectively, according to an embodiment of the present invention;

FIG. 13 shows a view of the RO filtrations system of FIGS. 4A-4C with the base detached from the magazine, according to an embodiment of the present invention;

FIG. 14 shows a view of the RO filtrations system of FIGS. 4A-4C with the lid detached from the magazine, according to an embodiment of the present invention;

FIGS. 15A and 15B show the latching system of FIGS. 4A-4C in a closed and open position, respectively, according to an embodiment of the present invention;

FIG. 16A shows a front top perspective view of the RO filtrations system of FIGS. 4A-4C without the housing covering the base, magazine, and lid, according to an embodiment of the present invention;

FIG. 16B shows a rear bottom perspective view of the RO filtrations system of FIGS. 4A-4C without the housing covering the base, magazine, and lid, according to an embodiment of the present invention;

FIG. 17 shows a view of the base of the RO filtration system of FIGS. 4A-4C without the housing covering the bottom of the base, according to an embodiment of the present invention;

FIG. 18 shows a view of the base of the RO filtration system of FIGS. 4A-4C without the housing covering the sides and top of the base and without the lever, according to an embodiment of the present invention; and

FIG. 19 shows a view of the RO filtration system of FIGS. 4A-4C without the housing covering the magazine and without the receptacle for receiving the battery, according to an embodiment of the present invention.

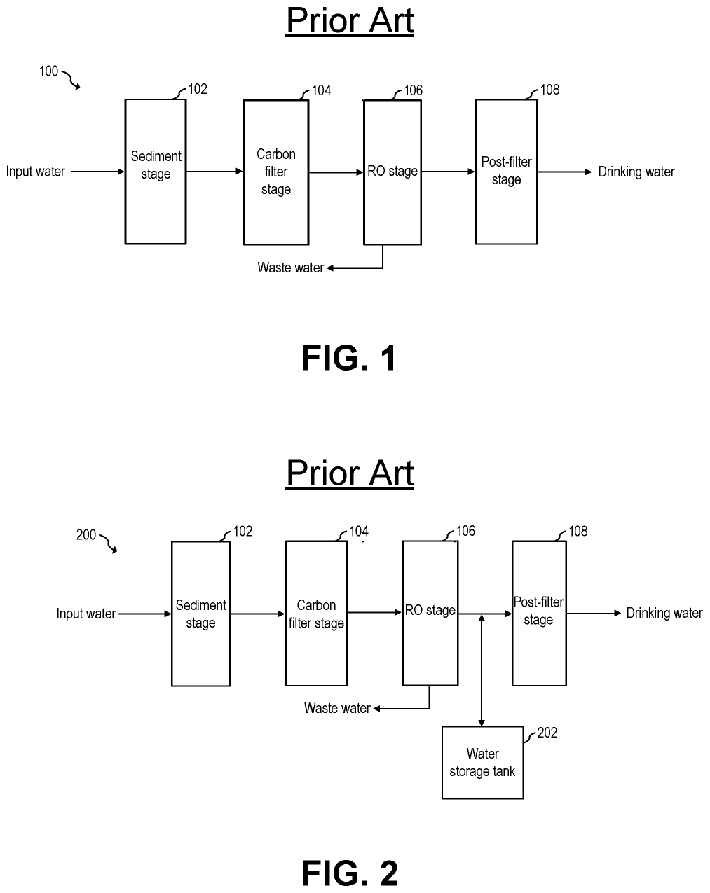

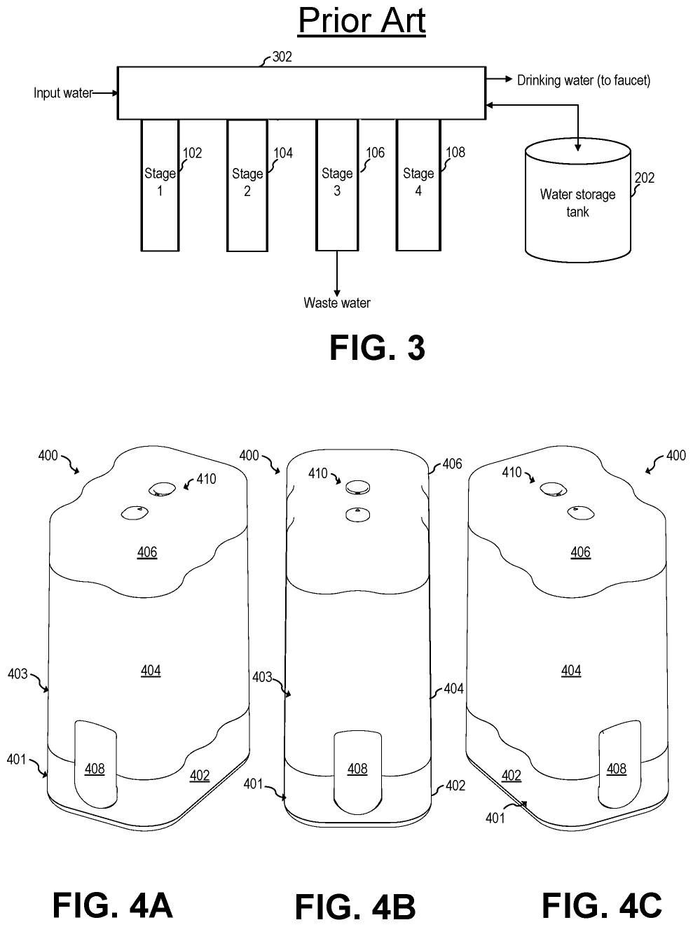

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the embodiments disclosed are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The description below illustrates the various specific details to provide an in-depth understanding of several example embodiments according to the description. The embodiments may be obtained without one or more of the specific details, or with other methods, components, materials and the like. In other cases, known structures, materials, or operations are not shown or described in detail so as not to obscure the different aspects of the embodiments. References to “an embodiment” in this description indicate that a particular configuration, structure, or feature described in relation to the embodiment is included in at least one embodiment. Consequently, phrases such as “in one embodiment” that may appear at different points of the present description do not necessarily refer exactly to the same embodiment. Furthermore, specific formations, structures, or features may be combined in any appropriate manner in one or more embodiments.

Embodiments of the present invention will be described in specific contexts, e.g., an RO water filtration system that is fully enclosed (excluding the water storage tank) and that is designed to be used under the sink. Some embodiments may be used in places other than under the sink, such as in a countertop, floor, etc. Some embodiments may be used without an RO filtration stage. Some embodiments may not be fully enclosed.

In an embodiment of the present invention, an RO filtration system is designed in a modular fashion, including a base and a magazine. The magazine, which includes water filter cartridges, is detachable from the base. The base is coupled (e.g., using water tubes) to the water line, the drain, the faucet, and the water storage tank. The base includes circuits for monitoring and controlling the operation and status of the RO filtration system. In some embodiments, the RO filtration system is powered by a battery housed inside the magazine. In some embodiments, the RO filtration system is not electrically coupled to mains.

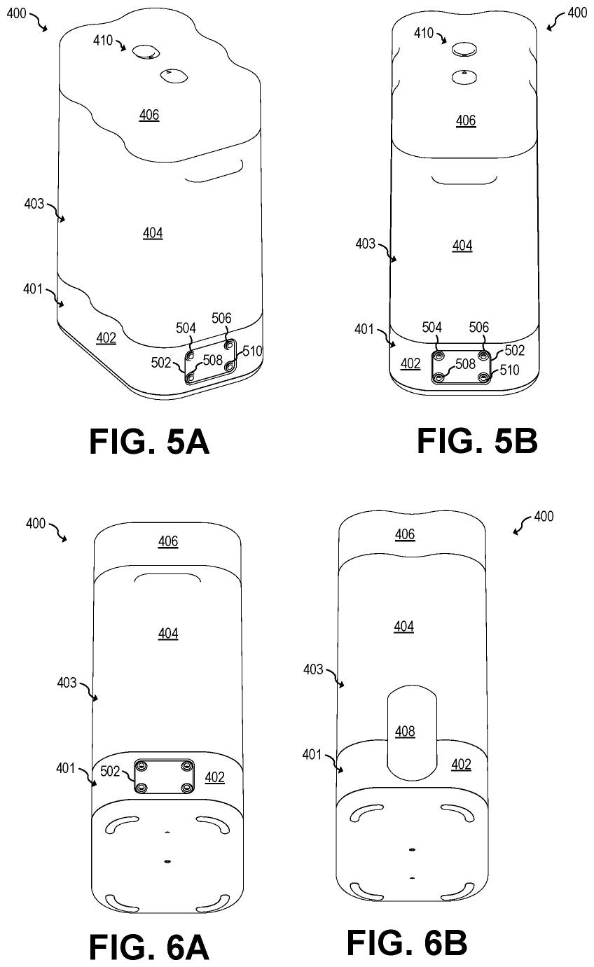

FIGS. 4A-6B shows various views of RO filtration system 400, according to an embodiment of the present invention. RO filtration system 400 includes base 402, magazine 404, and lid 406 (also referred to as cover 406).

For purposes of the description below, it is assumed that RO filtration system 400 is implemented as a 4-stage RO water filtration system including water filter stages 102, 104, 106, and 108, and water storage tank 202. However, it is understood that, in some embodiments, more than 4 stages of filtration (e.g., 5 or more), or less than 4 stages of filtration (e.g., 3 or less) may be used. In some embodiments, different types of filtration stages may be used. For example, some embodiments may not include the remineralization stage inside post-filter stage 108 and instead may include only a post-carbon filter. Some embodiments may not include post-filter stage 108. Some embodiments may not include an RO filtration stage. In some embodiments, the cartridge incorporating the carbon filter (e.g., 104) may include additional resins to remove additional dissolved solids. Other implementations are also possible.

In some embodiments, base 402 includes a panel that includes inlet manifold 502, e.g., for receiving input water, distributing water to/from a water storage tank (not shown), delivering drinking water to a faucet (not shown) and delivering wastewater to the drain. Base 402 also includes mechanical lever 408 for detaching base 402 from magazine 404. Base 402 also includes water tubing for directing the flow of water to/from the water filter stages (e.g., 102, 104, 106, 108). As will be described in more detail below, in some embodiments, base 402 also includes electronic circuits (not shown), sensors (not shown), e.g., for determining water quality, water flow, etc., and water valves (not shown).

In some embodiments, lever 408 may be implemented mechanically (e.g., as shown in FIGS. 4A-4C), where the lever 408 engages and causes magazine 404 to remain attached to base 402 when lever 408 is in a first position (e.g., vertical, as shown in FIGS. 4A-4C), and where lever disengages and causes magazine 404 to detached from base 402 when lever 408 is in a second position (e.g., horizontal, not shown in FIGS. 4A-4C). In some embodiments, the mechanism for keeping magazine 404 attached to base 402 and for detaching magazine 404 from base 402 may be implemented in other ways, such as by using an electronic switch and using a powered mechanism.

In some embodiments, base housing 401 covers sides, top, and bottom, of base 402, as shown in FIGS. 4A-6B, 12A-12B, and 13.

In some embodiments, magazine 404 includes, inside magazine housing 403, receptacles (not shown), e.g., for receiving water filter stages 102, 104, 106, 108, and a battery receptacle (not shown) for receiving a battery, e.g., for powering the electronic circuits of base 402. In some embodiments, magazine 404 also includes one or more sensors (which may be powered by the battery, e.g., via base 402).

In some embodiments, magazine housing 403 covers sides, and bottom of magazine 404 and partially covers the top of magazine 404, as shown in FIGS. 4A-6B, 13 and 14.

In some embodiments, lid 406 includes latching system 410 for detaching lid 406 from magazine 404, e.g., for allowing access to install/remove/replace water filters and/or a battery inside magazine 404.

As illustrated in FIGS. 4A-6B, in some embodiments, RO filtration system 400 fully encloses inside a housing (formed by housing 401 and 403 and lid 406) water filters, battery, electronic circuits, water tubing, sensors, a permeate pump, and water valves, which may advantageously result in less clutter (e.g., under the sink).

As can be seen in FIGS. 4A-6B, in some embodiments, magazine 404 may be detached from base 402, which may advantageously allow for moving magazine 404 to an area with more accessibility than under the sink (such as in the floor or in a kitchen countertop) for installing, removing, or replacing water filters and/or the battery.

As will be described in more detail below, in some embodiments, latching solenoid valves may be used to automatically stop the flow of input water from base 402 to magazine 404 upon actuation of lever 408, which may advantageously allow for the replacement of water filters and/or the battery without manually turning off the input water to RO filtration system 400.

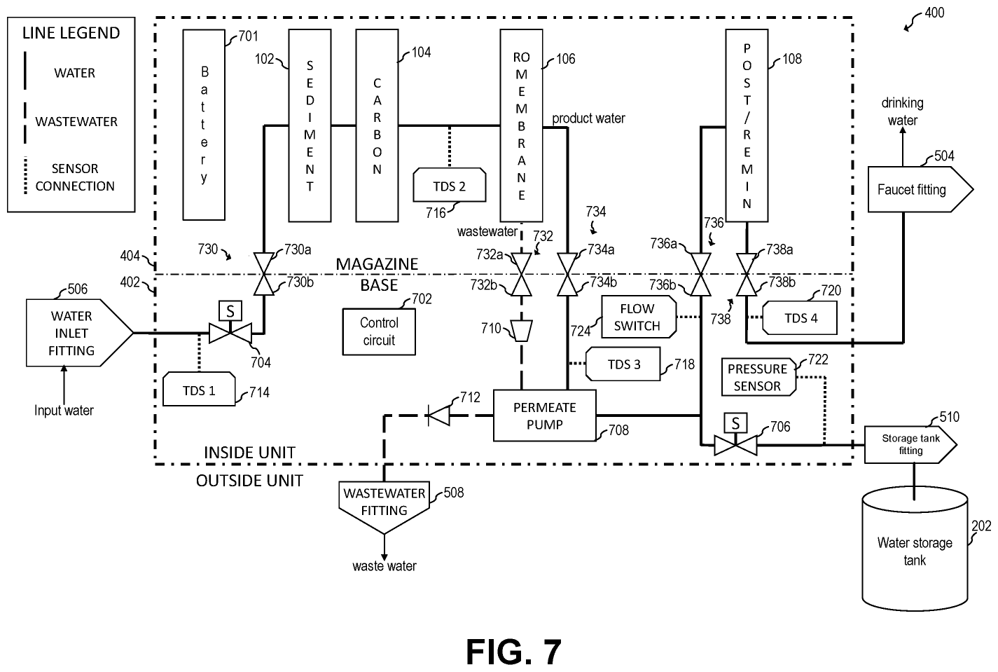

FIG. 7 shows a schematic diagram of RO filtration system 400, according to an embodiment of the present invention.

As shown in FIG. 7, in some embodiments, base 402 includes control circuit 702, latching solenoid valves 704 and 706, permeate pump 708, flow restrictor 710, check valve 712, total dissolved solids (TDS) sensors 714, 718 and 720, pressure sensor 722, flow switch 724, and manifold 729b, which includes poppet valves 730b, 732b, 734b, 736b, and 738b. In some embodiments, the manifold 502 of base 402 includes water inlet fitting 506, wastewater fitting 508, faucet fitting 504 and storage tank fitting 510.

In some embodiments, including inside base 402 (e.g., inside housing 401) all of the control components (e.g., 702, 704, 706, 708, 738) and most or all sensors (e.g., 714, 718, 720, 722, 724) may advantageously result in a less complex solution from a manufacturing perspective. In some embodiments, having all of the control components (e.g., 702, 704, 706, 708, 738) inside base 402 (e.g., inside housing 401) advantageously avoids disconnecting one or more control component from each other when magazine 404 is detached from base 402.

As shown in FIG. 7, in some embodiments, magazine 404 includes filtration stages 102, 104, 106, and 108, battery 701, TDS sensor 716, and manifold 729a, which includes poppet valves 730a, 732a, 734a, 736a, and 738a. Filters stages 102, 104, 106, and 108, and battery 701 may be implemented as (e.g., removable) cartridges.

In some embodiments, manifold 729a, which couples to manifold 729b, distributes water from/to base 402 to/from magazine 404.

As also shown in FIG. 7, poppet valves 730a, 732a, 734a, 736a, and 738a and poppet valves 730b, 732b, 734b, 736b, and 738b form poppet valve pairs 730, 732, 734, 736, and 738, which advantageously prevent water leakage (from base 402 and from magazine 404) when magazine 404 is detached from base 402. Poppet valves 730a, 732a, 734a, 736a, 738a, 730b, 732b, 734b, 736b, and 738b, may be implemented in any way known in the art.

TDS sensors 714, 716, 718, and 720 are configured to measure impurities in water (and thus provide a metric for water quality) of the respective water flow. For example, TDS sensor 714 is configured to detect impurities in the input water. TDS sensor 716 is configured to detect impurities in the water delivered by carbon filter 104. TDS sensor 718 is configured to detect impurities in the product water delivered by RO stage 106. TDS sensor 720 is configured to detect beneficial minerals and/or impurities in the drinking water (delivered by stage 108). TDS sensors 714, 716, 718, and 720 may be implemented in any way known in the art. For example, in some embodiments, TDS sensors 714, 716, 718, and 720 may include a water temperature calibration feature. Other implementations are also possible.

In some embodiments, TDS sensors may be used in other places, such as for monitoring the quality of the wastewater (the rejected water delivered by RO stage 106). In some embodiments, one or more (or all) TDS sensors 714, 716, 718, and 720 may be omitted. For example, in some embodiments in which stage 104 includes only a carbon filter (and no additional filtering media), TDS sensor 716 may be omitted.

In some embodiments, permeate pump 708 is configured to improve the water efficiency (the ratio between product water and wastewater) of RO stage 106 by using wastewater to create pressure to push product water into water storage tank 202 in a known manner. Permeate pump 708 may be implemented in any way known in the art.

In some embodiments, check valve 712 is configured to allow the flow of wastewater in one direction only (out through wastewater fitting 508). Check valve 712 may be implemented in any way known in the art.

In some embodiments, flow restrictor 710 is configured to restrict the flow of wastewater out of RO stage 106 to maintain high pressure inside the RO membrane of RO stage 106. Flow restrictor 710 may be implemented in any way known in the art.

In some embodiments, latching solenoid valves 704 and 706 are configured to open to allow water to flow through them and to close to prevent the flow of water through them based on control signals (e.g., provided by control circuit 702). Latching solenoid valves 704 and 706 may be implemented in any way known in the art.

In some embodiments, flow switch 724 is configured to detect when water is flowing into stage 108. Flow switch 724 may be implemented in any way known in the art. For example, in some embodiments, flow switch 724 is a mechanical switch that completes a circuit when activated (e.g., when water is flowing) and which opens the circuit when water is not flowing. Thus, in some embodiments, flow switch 724 does not consume electrical power.

In some embodiments, stages 102, 104, 106, and 108 may be implemented in any way known in the art. In some embodiments, one or more of stages 102, 104, 106, and 108 may be omitted or replaced with a different type of stage. For example, in some embodiments, stage 108 may be omitted and drinking water may be delivered directly from water storage tank 202. In some embodiments, more than 4 stages may be used for the water filtration process. Other implementations are also possible.

In some embodiments, water storage tank 202 is configured to store filtered water (e.g., from RO stage 106) and deliver the filtered water (e.g., to stage 108) when the faucet is open. Water storage tank 202 may be implemented in any way known in the art.

In some embodiments, pressure sensor 722 is configured to sense the pressure of water storage tank 202. In some embodiments, pressure sensor 722 may be used to provide an indication of how much water has passed through RO filtration system 400. Pressure sensor 722 may be implemented in any way known in the art.

In some embodiments, pressure sensor 722 may be used to determine when to open and close latching solenoid valve 704. For example, pressure sensor 722 may detect the water pressure in water storage tank 202, and when the water pressure reaches a set value, e.g., 45 psi, latching solenoid valve 704 closes to stop water flow from water inlet fitting 506. With this implementation, the valve 704 can be shut off electronically rather than mechanically.

In some embodiments, battery 701 is configured to provide power, e.g., directly or indirectly, to control circuit 702, latching solenoid valves 704 and 706, TDS sensors 714, 716, 718, and 720, and pressure sensor 722. Battery 701 may be implemented in any way known in the art. For example, in some embodiments, battery 701 is non-rechargeable. In some embodiments, battery 701 is rechargeable (e.g., via wired or wireless charging). In some embodiments, battery 701 is fully sealed. Other implementations are also possible.

In some embodiments, control circuit 702 is configured to control latching solenoid valves 704 and 706, receive information from TDS sensors 714, 716, 718, and 720, flow switch 724, and pressure sensor 722, and provide information to a user (e.g., an external device, such as a mobile device). In some embodiments, control circuit 702 may be implemented in a printed circuit board (PCB) and may include a general purpose or custom microcontroller or processor coupled to a memory and configured to execute instructions stored in the memory.

In some embodiments, water flows inside base 402 and inside magazine 404 through water tubes. For example, in some embodiments (and as illustrated in FIG. 7), water inlet fitting 506 is coupled to latching solenoid valve 704 via a water tube; TDS sensor 714 is coupled to poppet valve 730b via a water tube; poppet valve 730a is coupled to stage 102 via a water tube; stage 102 is coupled to stage 104 via a water tube; stage 104 is coupled to stage 106 via a water tube; stage 106 is coupled to poppet valves 732a and 734a using first and second water tubes, respectively; poppet valve 732b is coupled to flow restrictor 710 via a water tube; flow restrictor 710 is coupled to permeate pump 708 via a water tube; poppet valve 734b is coupled to permeate pump 708 via a water tube, permeate pump 708 is coupled to check valve 712 via a water tube; check valve 712 is coupled to wastewater fitting 508 via a water tube; permeate pump 708 is coupled to latching solenoid valve 706 via a water tube; latching solenoid valve 706 is coupled to storage tank fitting 510 via a water tube; latching solenoid valve 706 is coupled to poppet valve 736b via a water tube; poppet valve 736a is coupled to stage 108 via a water tube; stage 108 is coupled to poppet valve 738a via a water tube; and poppet valve 738b is coupled to faucet fitting 504 via a water tube. In some embodiments, water may be distributed inside base 402 and magazine 404 in other ways.

For example, in some embodiments, water may be routed between components with a flow manifold. The flow manifold may be implemented with plastic and components (e.g., valves, flow switch, TDS sensors, etc.) may be installed into the flow manifold. The flow manifold may have internal channels that route the water between components. Thus, in some embodiments, the flow manifold may be used instead of water tubing.

In some embodiments, tubing may be used in conjunction with a flow manifold. For example, if a single (or a few) components are far away from the flow manifold, a tube may be used to connect such single (or few) components to the flow manifold. As another example, tubing may be used to connect the flow manifold to a permeate pump. Other implementations are also possible.

As can be seen in FIG. 7, the water flows into base 402 from water inlet fitting 506, then then to magazine 404 via latching solenoid valve 704 and poppet valve pair 730, and then through filtering stages 102, 104, and 106. Wastewater flows from stage 106 back to base 402 via poppet valve pair 732 into permeate pump 708 and product water (clean water) flows from stage 106 to permeate pump 708 via poppet valve pair 734. Permeate pump 708 delivers product water to water storage tank 202 via latching solenoid valve 706 with the aid of the wastewater, and delivers wastewater to the drain via check valve 712 and wastewater fitting 508. When the faucet is open, clean water flows from water storage tank 202 to base 402 (via storage tank fitting 510) and then to stage 108 (in magazine 404) via latching solenoid valve 706 and poppet valve pair 736. Stage 108 delivers drinking water back to base 402 via poppet valve pair 738, and base 402 delivers drinking water out (e.g., to the faucet) via faucet fitting 504.

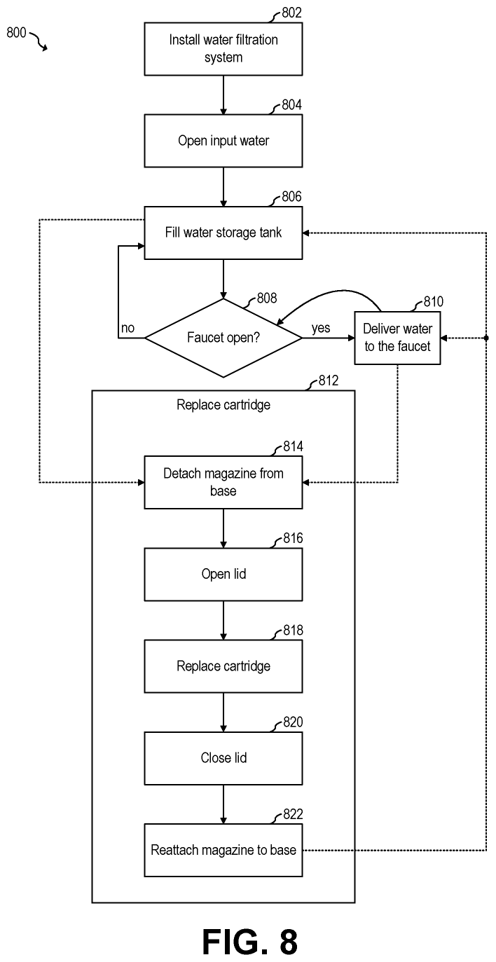

FIG. 8 shows a flow chart of embodiment method 800 for installing, operating, and maintaining RO filtration system 400, according to an embodiment of the present invention. FIG. 8 may be understood in view of FIGS. 4A-7.

During step 802, RO water filtration system 400 is installed (e.g., under the sink inside a kitchen cabinet). For example, in some embodiments, water inlet fitting 506 is connected to the cold water line under the sink for receiving water (e.g., from the city); wastewater fitting 508 is connected to a drain (e.g., sink drain) for delivering wastewater to the drain; storage tank fitting 510 is connected to water storage tank 202 for storing clean water in water storage tank 202 and for receiving clean water from water storage tank 202; and faucet fitting 504 is connected to a faucet for delivering drinking water. During step 802, the water filter stages (102, 104, 106, and 108) and battery are also installed in magazine 804.

Once all fittings of manifold 502 are connected, the water filter stages (102, 104, 106, 108) and battery (701) are installed, lid 406 is closed, and magazine 404 is attached to base 402, the water valve (connected to fitting 506) is open during step 804 to allow input water to flow into RO filtration system 400. In some embodiments, once battery 701 is installed and base 402 is attached to magazine 404, latching solenoid valves 704 and 706 are open to allow the flow of water through them. In some embodiments, the attaching of magazine 404 (containing a battery) to base 402 triggers control circuit 702 to open latching solenoid valves 704 and 706 (e.g., when lever 408 is engaged).

As water flows into RO filtration system 400, water flows through latching solenoid valves 704, poppet valve pair 730 and into stage 102, 104, and 106. Stage 106 outputs product water and wastewater, which are delivered to permeate pump 708 via poppet valve pairs 734 and 732, respectively. Permeate pump 708 delvers wastewater to wastewater fitting 508 and product water to either water storage tank 202 (via latching solenoid valve 706 and storage tank fitting 510) or the faucet (via poppet valve pair 736, stage 108, poppet valve pair 738 and faucet fitting 504) depending on whether the faucet is open and/or whether water storage tank 202 is full.

During step 806 (when the faucet is closed and water storage tank 202 is not full), product water flows from permeate pump 708 to water storage tank 202 via latching solenoid valve 706 and storage tank fitting 510. Once water storage tank 202 is full, product water stops flowing into water storage tank 202 and RO filtration system 400 becomes idle (no input water flowing into water inlet fitting 506, no product water flowing into water storage tank 202, and no drinking water flowing to the faucet).

As illustrated by steps 808 and 810, when the faucet is open, water flows from water storage tank to stage 108 to provide drinking water, which is delivered to the faucet until the faucet is closed or until water storage tank 202 is empty.

The process of replacing a cartridge, such one or more water filter stages (102, 104, 106, 108) and/or battery (701) is performed during step 812. As shown in FIG. 8, step 812 may be performed when water storage tank 202 is being filled, when water storage tank 202 is full or when the faucet is open, and without externally shutting off the flow of input water flowing into water inlet fitting 506.

During step 814, magazine 404 is detached from base 402 by actuating lever 408 (e.g., by pulling down lever 408 from a vertical position to a horizontal position). In some embodiments, the actuation of lever 408 to detach magazine 404 from base 402 also causes control circuit 702 to close latching solenoid valves 704 and 706 to prevent the flow of water from/to base 402 to/from magazine 404 and to/from water storage tank 202. For example, closing latching solenoid valve 704 interrupts the flow of input water into filtration stage 102. Closing latching solenoid valve 706 interrupts the flow of product water to water storage tank 202 or the flow of water from water storage tank 202 to stage 108. In some embodiments, closing latching solenoid valves 704 and 706 advantageously allows for detaching magazine 404 from base 402 (e.g., to replace water filters and/or battery 701) without shutting off the external water valve providing the input water.

In some embodiments, after closing latching solenoid valves 704 and 706, there may be water (e.g., pressurized or unpressurized) remaining in the water tubing of base 402 and magazine 404. Thus, in some embodiments, poppet valve pairs 730, 732, 734, 736, and 738 prevent water leakage of any water remaining in base 402 and magazine 404 after detachment of magazine 404 from base 402.

During step 816, lid 406 is detached from magazine 404 by actuating latching system 410 to access the top of magazine 404, which allows for removal and insertion of one or more cartridges, such as water filter stages 102, 104, 106, and/or 108, and/or battery 701.

During step 818, the one or more cartridges are removed from the cartridge receptacles new cartridges are inserted in the cartridge receptacles.

During step 820, lid 406 is reattached to magazine 404.

During step 822, magazine 404 is reattached to base 402. In some embodiments, upon reattachment of magazine 404 to base 402, control circuit 702 causes latching solenoid valves 704 and 706 to open to allow the flow of water through RO filtration system 400. After step 422, step 806 or 810 may be performed.

As illustrated in FIG. 8, some embodiments advantageously allow for replacing one or more water filters without turning off the input water. In some embodiments, the poppet valve pairs advantageously prevent base 402 and/or magazine 404 from leaking water that may be in the internal tubing after the closing of latching solenoid valves 704 and 706.

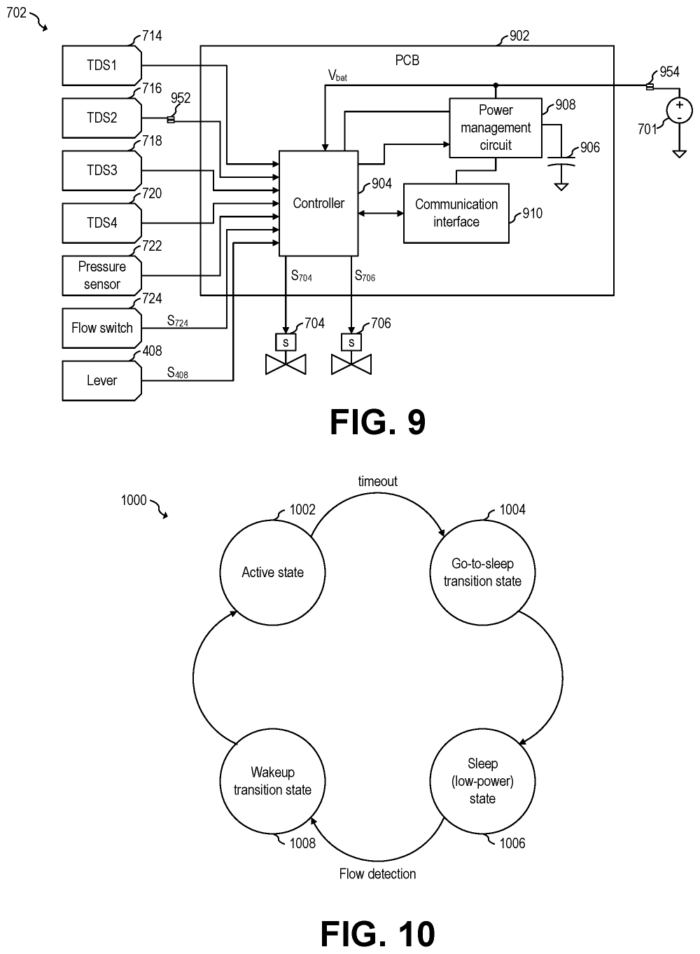

FIG. 9 shows an electrical schematic of a possible implementation of control circuit 702, according to an embodiment of the present invention. Control circuit 702 includes PCB 902, which includes controller 904, communication interface 910, supercapacitor 906, and power management circuit 908.

As shown in FIG. 9, control circuit 702 may receive signals from sensors (e.g., 714, 716, 718, 720, 722, 724) and switches (e.g., 408). For example, in some embodiments, lever 408 changes a position of a mechanical switch (not shown) to a first position when lever 408 engages (and causes magazine 404 to remain attached to base 402), and changes the position of the mechanical switch to a second position when lever 408 disengages (and causes magazine 404 to detach from base 402). The state of such mechanical switch may cause a circuit to close (e.g., in the first position) or open (e.g., in the second position), which may cause signal S₄₀₈ to assert in the first position and deassert in the second position. As another example, flow switch 724 may cause a mechanical switch (not shown) to close when water is flowing (and, e.g., assert signal S₇₂₄), and to open when water is not flowing (and, e.g., deassert signal S₇₂₄).

Although a single connection is shown from each of elements 714, 716, 718, 720, 722, 724, and 408 to controller 904, in some embodiments, more than one signal (e.g., multiple wires/traces) may be used. For example, in some embodiments, each of the TDS sensors (e.g., 714, 716, 718, 720) has 4 signals coming in/out, which include two sense wires for respective TDS probes to provide TDS sensor data to controller 904, and two sense wires for an integrated thermistor used to collect temperature data of the water and provide such temperature data to controller 904 for temperature correction. In some embodiments, the TDS measurement circuit is implemented inside controller 904.

In some embodiments, power management circuit 908 is configured to receive power from battery 701 and provide power to controller 904 and communication interface 910. In some embodiments, power management circuit 908 also provides power to circuits outside control circuit 702, such as to sensors 714, 716, 718, 720, and/or 722. In some embodiments, power management circuit 908 is configured to keep supercapacitor 906 fully charged (e.g., by constantly trickle charging supercapacitor 906).

In some embodiments, power management circuit 908 includes one or move voltage converters (e.g., LDO, SMPS) for generating, in a known manner, suitable voltages for power various circuits (e.g., 904, 910, 714, 716, 718, 720, 722).

In some embodiments, controller 904 is configured to receive sensor data from one or more sensors (e.g., 714, 716, 718, 720, 722, and/or 724) and provide information based on the received data to an external user (e.g., a screen, mobile device, etc.) using communication interface 910. In some embodiments, controller 904 is also configured to control the state (open/close) of latching solenoid valves 704 and 706 (e.g., based on the output of flow switch 724).

In some embodiments, controller 904 is implemented with a generic or custom microcontroller or processor coupled to a memory and configured to execute instructions from the memory. In some embodiments, controller 904 includes a state machine. Other implementations are also possible.

Communication interface 910 is configure to communicate with one or more external users, such as mobile phones, external controllers or circuits, a screen/display of the RO filtration system 400, etc. Communication interface 910 may include a wire and/or wireless communication interfaces, such as WiFi, Bluetooth, SPI, I2C, etc.

In some embodiments, supercapacitor 906 is sized to store enough energy for actuating (e.g., closing) latching solenoid valves 704 and 706 at least once and for sensing the disconnection of battery 701.

In some embodiments, battery 701 is not rechargeable. To extend the battery life of battery 701, some embodiments transition into a sleep mode when not in use (e.g., when not delivering drinking water to the faucet), and wake up when flow of water (e.g., to the faucet) is detected (e.g., by flow switch 724). In some embodiments, by using sleep mode, the battery life of battery 701 may be advantageously extended, without charging or replacing the battery 701, to longer than 1 year (such as 1.5 years, 2 years, or more), while periodically providing (when in an active state) information to a user (e.g., via communication interface 910) related to the quality of water and status of RO filtration system 400, and while controlling the operation of RO filtration system 400 (e.g., by actuating lathing solenoid valves 704 and 706 when triggered).

For example, in some embodiments, RO filtration system 400 includes a sleep (low-power) state and an active state of operation. During active state, control circuit 702 powers sensors 714, 716, 718, 720 and 722 (e.g., via power management circuit 908), receives data from sensors 714, 716, 718, 720 and 722 (e.g., with controller 904), and delivers information based on the received data to an external user (e.g., using communication interface 910). Example of information provided to the external user may include quality of input water (e.g., based on TDS sensor 714), quality of water after filtration stage 104 (e.g., based on TDS sensor 716), quality of product water (e.g., based on TDS sensor 718), quality of drinking water (e.g., based on TDS sensor 720), volume of water run through the RO filtration system 400 (e.g., based on pressure sensor 722), pressure inside the water storage tank 202 (e.g., based on pressure sensor 722), health of water storage tank 202 (e.g., based on pressure sensor 722), health of filtration cartridges 1402 and 1404 (e.g., based on TDS sensors 714 and 716), health of filtration cartridge 1406 (e.g., based on TDS sensors 716 and 718), health of post-filter cartridge 1408 (e.g., based on TDS sensors 718 and 720), and/or health/status of battery 701 (e.g., based on battery voltage V_{bat}).

In some embodiments, during sleep state, control circuit 702 is in a low-power state, e.g., to preserve power and extend the battery life of battery 701. For example, in some embodiments, in sleep state, communication interface 910 is off, sensors 714, 716, 718, 720, 722 and 724 are unpowered, one or more internal circuits of power management circuit 908 are off or in a low-power state, and controller 904 is in a low power state.

FIG. 10 shows a state diagram of state machine 1000, according to an embodiment of the present invention. State machine 1000 may be implemented by controller 904.

During sleep state 1006, RO filtration system 400 is in a low-power state. For example, during sleep state 1006, sensors 714, 716, 718, 720 and 722 are unpowered and communication interface 910 is off or in a low-power state. When the faucet is open to deliver drinking water (e.g., from water storage tank 202), flow switch 724 detects such flow of water and causes signal S₇₂₄ to be asserted (activated, e.g., high). Controller 904 detects the assertion of signal S₇₂₄ and transitions to wakeup transition state 1008.

During wakeup transition state 1008, power management circuit 908 exits low-power state and provides power to sensors 714, 716, 718, 720, and 722, and to communication interface 910, communication interface 910 is turned on, controller 904 exits low power state, and controller 904 transitions to active state 1002.

During active state 1002, in addition to receiving, processing, and delivering sensor data, controller 904 starts, upon closing of the faucet (e.g., step 808, output “no”) a watchdog timer indicative of the time elapsed without delivering drinking water via the faucet. Once the watchdog timer expires (e.g., after 120 minutes), controller 902 transitions into a go-to-sleep transition state 1004 in which communication interface 910 is turned off, sensors 714, 716, 718, 720 and 722 are turned off, one or more internal circuits of power management circuit 908 are turned off or into a low-power state, and controller 904 transitions into sleep state 1006. In some embodiments, controller 904 detects whether the faucet is open or closed based on signal S₇₂₄.

In some embodiments, controller 902 may exit sleep state 1006 when a timeout wakeup circuit asserts a wakeup signal (not shown). In such embodiments, the timeout wakeup circuit remains powered and active during sleep state 1006. In some embodiments, the timeout wakeup circuit is implemented by controller 902. Other implementations are also possible.

In some embodiments, a transition between sleep state 1006 and active state 1002 may be triggered in other ways, such as via communication interface 910 (e.g., by using an app of a mobile device), or by pressing a button coupled to controller 904.

In some embodiments, a transition between active state 1002 and sleep state 1006 may be triggered in other ways, such as via communication interface 910 (e.g., by using an app of a mobile device), or by pressing a button coupled to controller 904.

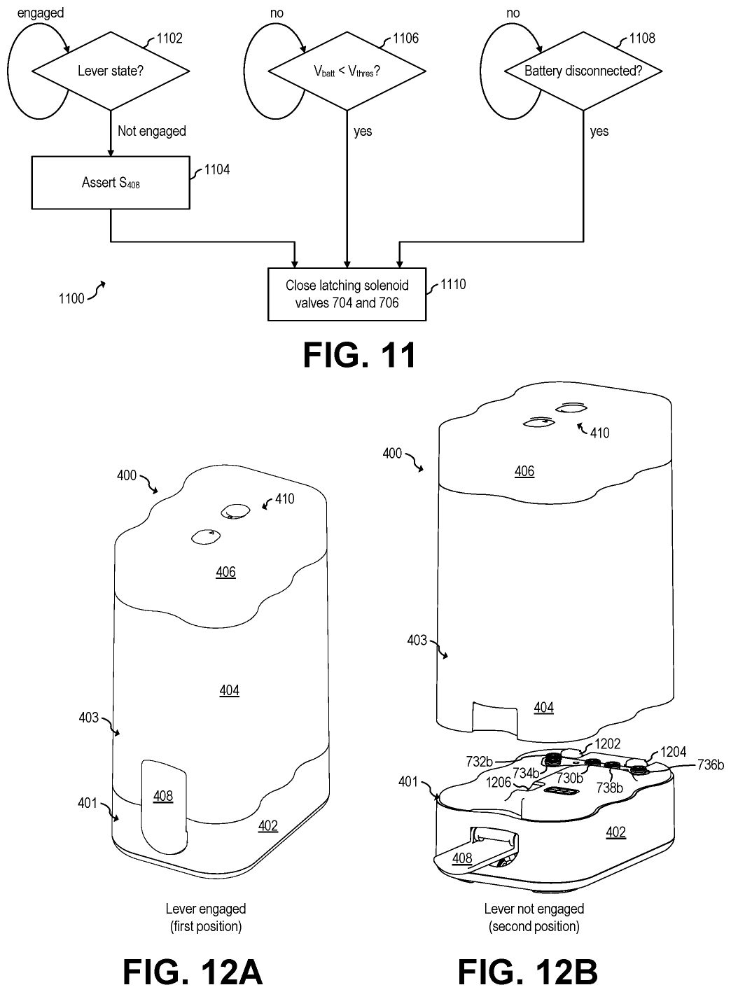

As shown in FIGS. 7 and 9, in some embodiments, controller 904 controls the state of latching solenoid valves 704 and 706, e.g., to prevent the flow of water into/out of base 402 and magazine 404. FIG. 11 shows a flow chart of embodiment method 1100 for determining when to close latching solenoid valves 704 and 706, according to an embodiment of the present invention.

During step 1110, controller 904 causes the (e.g., simultaneous) opening of latching solenoid valves 704 and 706, e.g., by asserting (e.g., high) signals S₇₀₄ and S₇₀₆. As shown in FIG. 11, in some embodiments, there may be a plurality of ways to cause the opening of latching solenoid valves 704 and 706.

A way of causing the performance of step 1110 is based on the state of lever 408 (steps 1102, 1104). For example, in some embodiments, during step 1102, the state of lever 408 is monitored, e.g., by controller 904 (e.g., by monitoring the status of signal S₄₀₈). When lever 408 is engaged (in a first position), base 402 is attached to magazine 404, latching solenoid valves 704 and 706 are open and water flows in/out of RO filtration system 400. When lever 408 is not engaged (in a second position), magazine 404 detaches from base 402 (e.g., step 814), and signal S₄₀₈ is asserted (e.g., high) during step 1104. In some embodiments, signal S₄₀₈ is asserted by lever 408 mechanically flipping a switch inside base 402.

In some embodiments, in response to the assertion of signal S₄₀₈, controller 904 causes the closing of latching solenoid valves 704 and 706 during step 1110. In some embodiments, step 1102 may be omitted and controller 904 may asynchronously perform step 1110 upon assertion of signal S₄₀₈.

By closing latching solenoid valves 704 and 706 when lever 408 is not engaged, some embodiments advantageously allow for the replacement of cartridges (e.g., step 812) without turning off the input water to the filtration system.

Another way of causing the performance of step 1110 is based on the status of battery 701 (steps 1106, 1108). For example, in some embodiments, the battery voltage V_{bat} is monitored (e.g., by controller 904) during step 1106. When the battery voltage V_{bat} is below a predetermined threshold Vₜₕᵣₑₛ, controller 904 causes the closing of latching solenoid valves 704 and 706 during step 1110. In some embodiments, predetermined threshold Vₜₕᵣₑₛ corresponds to a battery voltage indicative of low battery (such as 10% of battery remaining). In some embodiments, controller 904 may use energy from battery 701 and/or from supercapacitor 906 to cause the closing of latching solenoid valves 704 and 706 during step 1110.

In some embodiments, the predetermine threshold Vₜₕᵣₑₛ may be different. For example, in some embodiments, predetermined threshold Vₜₕᵣₑₛ corresponds to a battery voltage indicative of 8% of battery remaining or lower, or 15% of battery remaining or higher).

In some embodiments, it is possible for lid 406 to be detached from magazine 404 and for battery 701 to be removed from magazine 404 while magazine 404 is attached to base 402 and lever 408 is engaged. In such situation, upon detection of a battery disconnection event during step 1108, the energy stored in supercapacitor 906 is used to close latching solenoid valves 704 and 706 during step 1110.

As illustrated by steps 1106 and 1108, some embodiments may advantageously prevent water leaks, e.g., by avoiding a situation in which not enough power is left in battery 701 to close latching solenoid valves 704 and 706, e.g., in response to the detaching of magazine 404 from base 402 (e.g., during step 814).

In some embodiments, a battery disconnection event (during step 1108) may be determined by controller 904 based on voltage V_{bat}. In some embodiments, step 1108 may be omitted, and may be indirectly performed by step 1106 (since a battery disconnection event may cause V_{bat} to drop below Vₜₕᵣₑₛ).

In some embodiments, step 1110 may be performed in response to the detaching of lid 406 from magazine 404 (e.g., by sensing the actuation of latching system 410 or by using a separate sensor).

In some embodiments, latching solenoid valves 704 and 706 are opened when lever 408 is engaged, and battery 701 is above Vₜₕᵣₑₛ (and, optionally, when lid 406 is attached to magazine 404).

FIGS. 12A and 12B show RO filtration system 400 with lever 408 engaged and not engaged, respectively, according to an embodiment of the present invention. When lever 408 is engaged (as shown in FIG. 12A), latches/hooks 1202, 1204, and 1206 keep magazine 404 attached to base 402. In some embodiments, more than 3 latches/hooks, such as 4 or more may be used. In some embodiments, less than 3 latches/hooks (e.g., 2 latches/hooks) may be used. Latches/hooks 1202, 1204, and 1206 may be implemented in any way known in the art.

When lever 408 is not engaged (as shown in FIG. 12B), latches/hooks 1202, 1204, and 1206 release magazine 404, which, in some embodiments, may be advantageously safely detached from base 402 without risk of water leakage thanks to the closing of latching solenoid valves 704 and 706 and to poppet valves 730, 732, 734, 736, and 738.

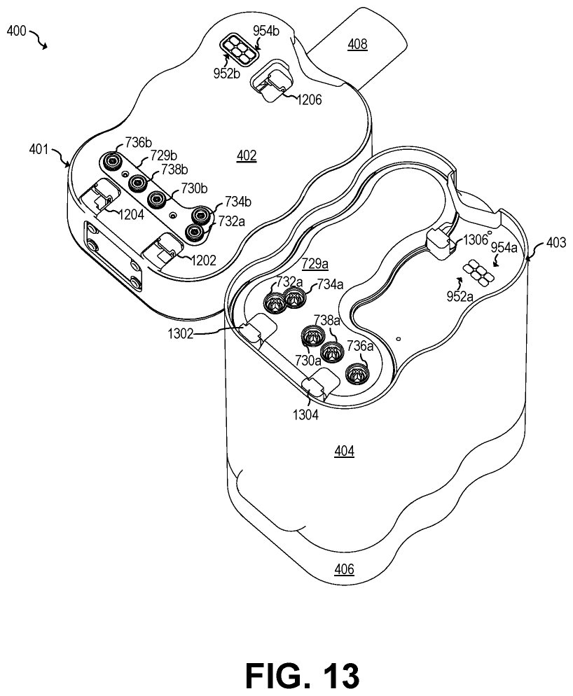

FIG. 13 shows a view of RO filtrations system 400 with base 402 detached from magazine 404, according to an embodiment of the present invention. As can be seen from FIG. 13, latch/hooks 1202, 1204, and 1206 are aligned with receptacles 1302, 1304, and 1306, respectively, to allow for the attaching/detaching by actuation of lever 408.

As also shown in FIG. 13, poppet valves 730a, 732a, 734a, 736a, and 738a are respectively aligned with poppet valves 730b, 732b, 734b, 736b, and 738b to allow for water flow when base 402 is attached to magazine 404. Poppet valves 730a, 732a, 734a, 736a, and 738a prevent water leakage from magazine 404 when magazine 404 is detached from base 402. Poppet valves 730b, 732b, 734b, 736b, and 738b prevent water leakage from base 402 when base 402 is detached from magazine 404.

Contact connectors 952a, 952b, 954a and 954b (collectively, contact connectors 952 and 954) are also illustrated in FIG. 13. In the embodiment illustrated in FIG. 13, contact connector 952 includes 4 contacts and contact connector 954 includes 2 contacts (power and ground) for a total of 6 contact connectors. In some embodiments, less or more than 6 contact connectors may be used. For example, in some embodiments, magazine 404 does not include any TDS sensors and only 2 contact connectors (for power and ground) for coupling battery 701 to control circuit 702 are used. In some embodiments, magazine 404 may include additional sensors and/or other circuits that may use additional contact connectors.

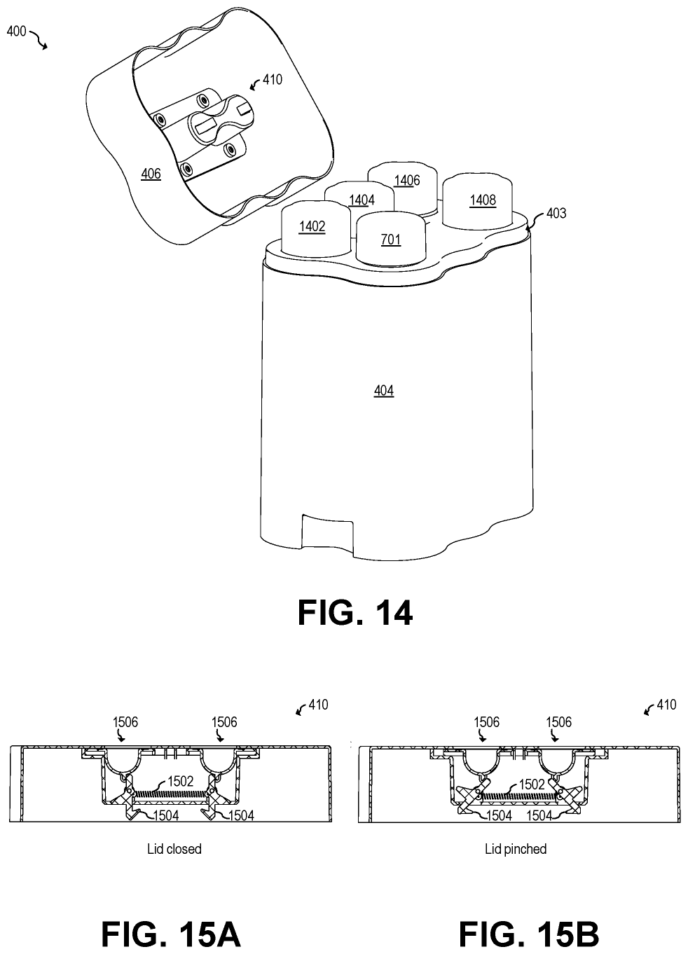

FIG. 14 shows a view of RO filtrations system 400 with lid 406 detached from magazine 404, according to an embodiment of the present invention. As shown in FIG. 14, cartridges 1402, 1404, 1406, 1408, and 701 are accessible (e.g., for replacement) when lid 406 is detached from magazine 404. FIG. 14 also shows the inside portion of latching system 410, which is configured to attach to magazine 404, e.g., by attaching to a receptacle in magazine 404 (not shown), and which is configured to release the receptacle of the magazine and allow for detachment of lid 406 from magazine 404 upon actuation of the latching system 410.

FIGS. 15A and 15B show latching system 410 in a closed and open position, respectively, according to an embodiment of the present invention. As shown in FIGS. 15A and 15B, in some embodiments, latching system 410 includes spring 1502, hooks 1504, and receptacles 1506 (e.g., for receiving the fingers of a user).

As shown in FIG. 15A, when lid 406 is attached to magazine 404, hooks 1504 oriented so as to grab magazine 404. As shown in FIG. 15B, upon actuation of latching system 410, e.g., by pulling inward receptacles 1506 using two fingers, hooks 1504 separate, thus releasing magazine 404 and allowing for lid 406 to be detached from magazine 404.

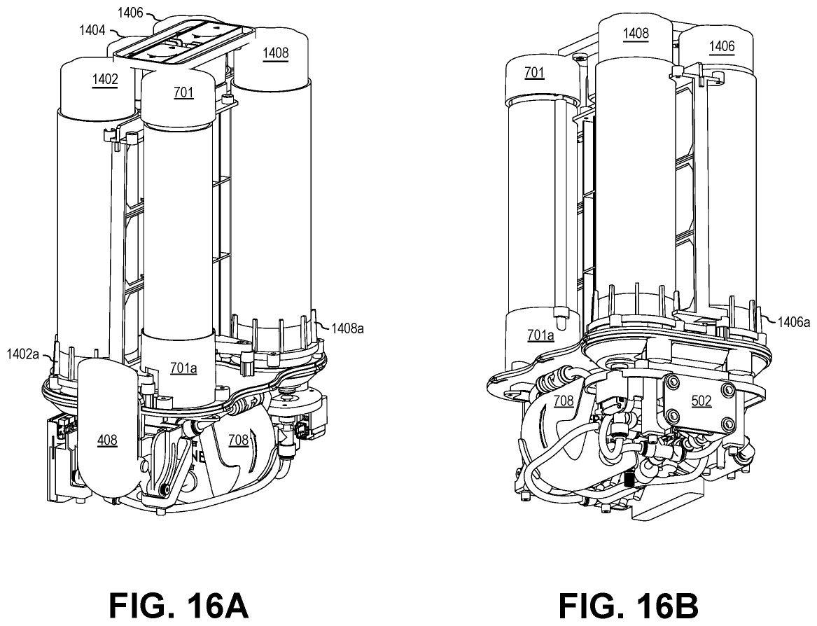

FIGS. 16A and 16B show various views of RO filtrations system 400 without the housing covering base 402, magazine 404, and lid 406, according to an embodiment of the present invention. Cartridges 1402, 1404, 1406, 1406, and 701 attached to receptacles 1402a, 1404a (not shown), 1406a, 1408a, and 701a.

As shown, in some embodiments, receptacles 1402a, 1404a, 1406a, 1408a and 701a may be round receptacles in which respective cartridges can be screwed in or otherwise attached to. Other implementations are also possible.

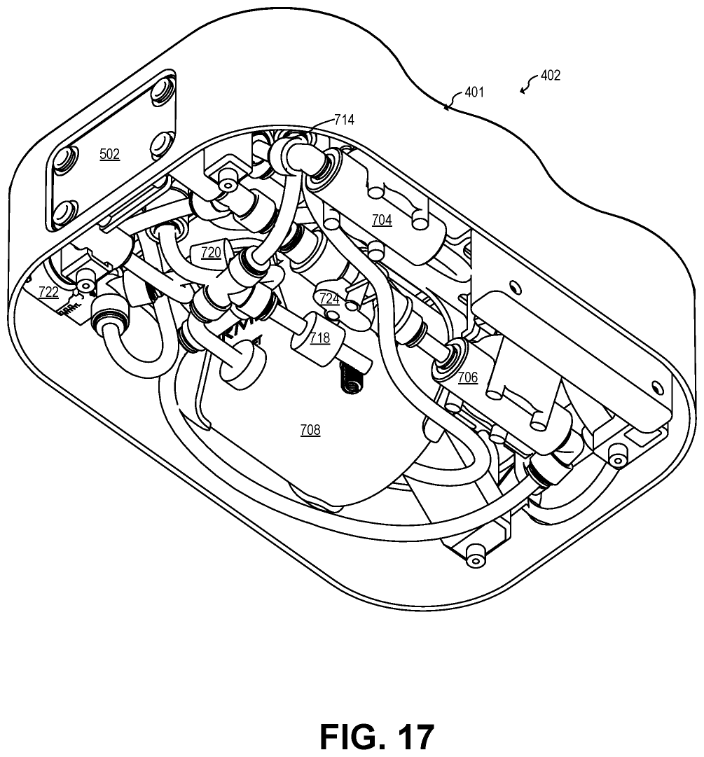

FIG. 17 shows a view of base 402 without the housing covering the bottom of base 402, according to an embodiment of the present invention. FIG. 17 illustrates the relative position of latching solenoid valves 704 and 706, flow switch 724, permeate pump 708, water tubing and TDS sensors 714, 718, and 720 inside base 402.

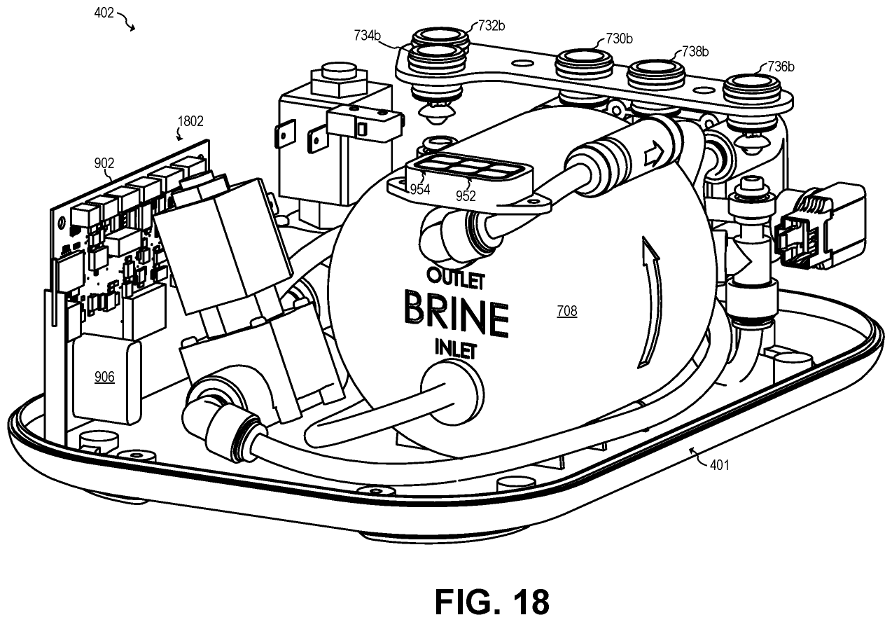

FIG. 18 shows a view of base 402 without the housing covering the sides and top of base 402 and without lever 408, according to an embodiment of the present invention. As shown, PCB 902 is disposed vertically, with connectors 1802 (e.g., for connecting PCB 902 to battery 701, valves 704 and 706, sensors 714, 716, 718, 720, 722, 724, contacts 952 and 954, etc.) facing upward. In some embodiments, implementing connectors 1802 facing the same direction (e.g., in the top edge of PCB 902) may advantageously allow for ease of access during assembly, which may simplify the assembly process (e.g., during manufacturing).

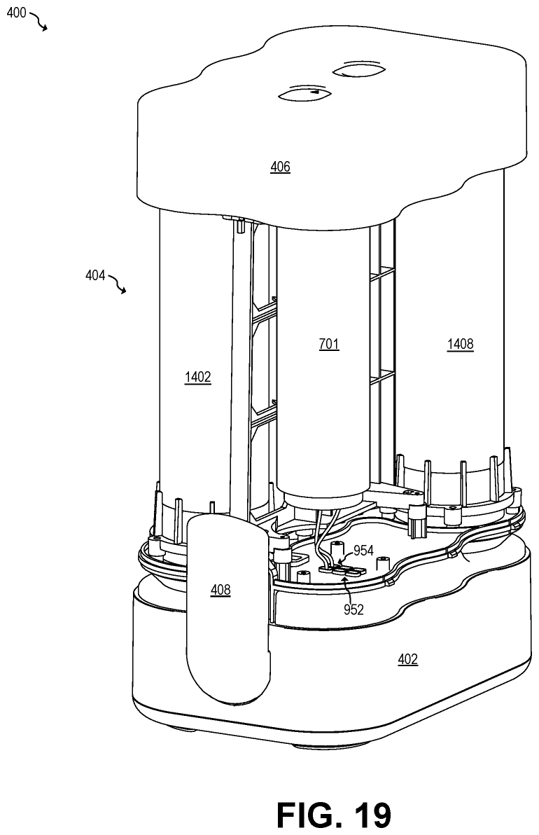

FIG. 19 shows a view of RO filtration system 400 without the housing covering magazine 404 and without receptacle 701a, according to an embodiment of the present invention. As shown in FIG. 19, in some embodiments, battery 701 is connected to contact connectors 954 using two cables (power and ground).

In some embodiments, the component arrangement illustrated in FIGS. 4A-6B, 13, and 16-19, such as the relative location and orientation of PCB 902, the relative location of contact connectors 952 and 954, the relative location of cartridges 1402, 1404, 1406, 1408, and 701, the location of TDS sensors 714, 718, and 720, the relative location of poppet valves 730, 732, 734, 736, and 738, the relative location of permeate pump 708, the relative location of pressure sensor 722, and the relative location of lever 408 and manifold 502, advantageously allow for a compact implementation.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A modular water filtration system comprising:
a magazine comprising:
a plurality of cartridge receptacles for a plurality of cartridges, wherein a first cartridge receptacle of the plurality of cartridge receptacles is configured to receive a water filter cartridge,
a magazine input water valve, and
a magazine output valve, wherein the first cartridge receptacle is coupled between the magazine input water valve and the magazine output valve; and
a base comprising:
a first fitting configured to receive input water,
a second fitting configured to provide drinking water,
a base input water valve configured to be coupled to the magazine input water valve,
a first solenoid valve having a water path coupled between the first fitting and the base input water valve,
a base first valve configured to be coupled to the magazine output valve, and
a first switch, wherein the base is configured to detach from the magazine and cause the first solenoid valve to close when the first switch transitions from a first state to a second state.

2. The water filtration system of claim 1, wherein the base further comprises:
a third fitting configured to be coupled to a water storage tank; and
a second solenoid valve having a water path coupled between the base first valve and the third fitting, wherein the base is configured to cause the second solenoid valve to close when the first switch transitions from a first state to a second state.

3. The water filtration system of claim 2, wherein the base further comprises a permeate pump coupled to the base first valve via a first water tube, and coupled to the second solenoid valve via a second water tube.

4. The water filtration system of claim 3, wherein the base comprises a base housing that fully encloses the first and second solenoid valves, and the permeate pump.

5. The water filtration system of claim 2, wherein the base further comprises a pressure sensor coupled to a first water tube that is coupled between the second solenoid valve and the third fitting, wherein the pressure sensor is configured to sense a pressure of the water storage tank.

6. The water filtration system of claim 5, wherein the pressure sensor is configured to provide a signal to the first solenoid valve when the pressure of the water storage tank reaches a set value so that the first solenoid valve can close to stop water flow from the first fitting.

7. The water filtration system of claim 2, wherein the base comprises an inlet manifold that comprises the first, second, and third fittings, the inlet manifold being located in a first side of the base, wherein the first switch is located in a second side of the base, the second side being opposite to the first side.

8. The water filtration system of claim 1, wherein the magazine further comprises a first total dissolved solids (TDS) sensor coupled to a first water tube that is coupled between the first cartridge receptacle and the magazine output valve, wherein the first TDS sensor is configured to sense a quality of water flowing through the first water tube.

9. The water filtration system of claim 8, wherein the magazine further comprises a first magazine connector configured to be electrically coupled to a first base connector of the base, and wherein the first TDS sensor is electrically coupled to the first magazine connector.

10. The water filtration system of claim 1, wherein the plurality of cartridge receptacles comprises a second cartridge receptacle configured to receive a battery, and wherein the magazine further comprises a first magazine connector configured to be electrically coupled to a first base connector of the base, the first magazine connector being electrically coupled to the second cartridge receptacle and configured to be electrically coupled to the battery.

11. The water filtration system of claim 10, wherein the magazine further comprises a battery cartridge coupled to the second cartridge receptacle.

12. The water filtration system of claim 11, wherein the battery cartridge comprises a non-rechargeable battery that is fully sealed.

13. The water filtration system of claim 10, wherein the base further comprises a control circuit coupled to the first base connector of the base and configured to be coupled to the battery via the first base connector of the base, wherein the control circuit is configured to detect the transition of the first switch from the first state to the second state and, in response to the detection of the transition, cause the closing of the first solenoid valve.

14. The water filtration system of claim 13, wherein the control circuit comprises a supercapacitor, the control circuit being configured to detect a disconnection of the battery from the control circuit, and, in response to the detection of disconnection, cause the closing of the first solenoid valve using energy stored in the supercapacitor.

15. The water filtration system of claim 13, wherein the control circuit comprises a supercapacitor, the control circuit being configured to cause the closing of the first solenoid valve using energy stored in the supercapacitor when a battery voltage of the battery drops below a predetermined threshold.

16. The water filtration system of claim 1, wherein the first cartridge receptacle is configured to receive a reverse osmosis (RO) filter cartridge.

17. The water filtration system of claim 1, wherein the plurality of cartridge receptacles comprises a second cartridge receptacle configured to receive a post-filter cartridge that comprises remineralization media.

18. The water filtration system of claim 1, wherein the plurality of cartridge receptacles comprises second, third, and fourth cartridge receptacles.

19. The water filtration system of claim 18, wherein the magazine further comprises:
a sediment filter cartridge coupled to the first cartridge receptacle;
a carbon filter cartridge coupled to the second cartridge receptacle;
a reverse osmosis (RO) filter cartridge coupled to the third cartridge receptacle; and
a post-filter cartridge coupled to the fourth cartridge receptacle.

20. The water filtration system of claim 19, further comprising a detachable lid configured to be coupled to the magazine, wherein the magazine further comprises a magazine housing, and wherein, when the lid is attached to the magazine, the lid and the magazine housing fully enclose the sediment filter cartridge, the carbon filter cartridge, the RO filter cartridge and the post-filter cartridge.

21. The water filtration system of claim 18, wherein the magazine further comprises:
a magazine first valve coupled to a wastewater line of the third cartridge receptacle, wherein the magazine output valve is coupled to a product water line of the third cartridge;
a magazine second valve coupled to an input line of the fourth cartridge receptacle; and
a magazine third valve coupled to an output line of the fourth cartridge receptacle.

22. The water filtration system of claim 21, wherein the base further comprises:
a base second valve configured to be coupled to the magazine first valve;
a base third valve configured to be coupled to the magazine second valve, the base third valve coupled to the base second valve via a first water tube; and
a base fourth valve configured to be coupled to the magazine third valve, wherein the base fourth valve is coupled to the second fitting.

23. The water filtration system of claim 1, wherein the first switch comprises a mechanical lever, and wherein the first switch transitioning from the first state to the second state comprises the lever transitioning from a first position to a second position.

24. The water filtration system of claim 1, wherein the magazine input water valve, the magazine output valve, the base input water valve and the base first valve are poppet valves, and wherein, when the magazine is attached to the base, the magazine input water valve and the base input water valve are aligned so as to form a first poppet valve pair that is configured to allow input water flowing from the base to the magazine, and the magazine output valve and the base first valve are aligned so as to form an second poppet valve pair that is configured to allow product water flowing from the magazine to the base.

25. The water filtration system of claim 1, wherein the base further comprises a first total dissolved solids (TDS) sensor coupled to a first water tube that is coupled between the first fitting and the base input water valve, wherein the first TDS sensor is configured to sense a quality of water flowing through the first water tube.

26. The water filtration system of claim 25, wherein the base further comprises a control circuit configured to receive sensor data from the first TDS sensor, the control circuit comprising a communication interface circuit, wherein the control circuit is configured to transmit information based on the sensor data using the communication interface circuit.

27. The water filtration system of claim 26, wherein the base further comprises a flow switch coupled to a first water tube that is coupled to the second fitting, the flow switch configured to sense a flow of water through the first water tube, wherein the control circuit is configured to transition from a low-power state to an active state based on an output of the flow switch.

28. The water filtration system of claim 27, wherein the control circuit is configured to transmit the information using the communication interface circuit in a wireless manner.

29. The water filtration system of claim 1, further comprising a lid comprising a latching system configured to detach the lid from the magazine, wherein the plurality of cartridge receptacles is accessible when the lid is detached from the magazine.

30. The water filtration system of claim 1, wherein the water filtration system is configured to be electrically disconnected from mains.

31. A base configured to be attached to a magazine of a water filtration system, the base comprising:
a first fitting configured to receive input water,
a second fitting configured to provide drinking water with less impurities than the input water,
a base input water valve configured to be coupled to a magazine input water valve of the magazine,
a first solenoid valve having a water path coupled between the first fitting and the base input water valve,
a base first valve configured to be coupled to a magazine output valve of the magazine, and
a first switch, wherein the base is configured to detach from the magazine and cause the first solenoid valve to close when the first switch transitions from a first state to a second state, and wherein the base does not comprise a water filter or water filter receptacle.

32. The base of claim 31, further comprising:
a third fitting configured to be coupled to a water storage tank; and
a second solenoid valve having a water path coupled between the base first valve and the third fitting, wherein the base is configured to cause the second solenoid valve to close when the first switch transitions from a first state to a second state.

33. The base of claim 32, wherein the base further comprises a permeate pump coupled to the base first valve via a first water tube, and coupled to the second solenoid valve via a second water tube.

34. The base of claim 33, wherein the base comprises a base housing that fully encloses the first and second solenoid valves, and the permeate pump.

35. The base of claim 32, wherein the base further comprises a pressure sensor coupled to a first water tube that is coupled between the second solenoid valve and the third fitting, wherein the pressure sensor is configured to sense a pressure of the water storage tank.

36. The base of claim 32, wherein the base comprises an inlet manifold that comprises the first, second, and third fittings, the inlet manifold being located in a first side of the base, wherein the first switch is located in a second side of the base, the second side being opposite to the first side.

37. The base of claim 31, further comprising:
a first base connector configured to receive power from the magazine; and
a control circuit coupled to the first base connector, wherein the control circuit is configured to detect the transition of the first switch from the first state to the second state and, in response to the detection of the transition, cause the closing of the first solenoid valve.

38. The base of claim 37, wherein the control circuit comprises a supercapacitor, the control circuit being configured to detect an interruption of power received from the first base connector, and, in response to the detection of the interruption of power, cause the closing of the first solenoid valve using energy stored in the supercapacitor.

39. The base of claim 37, wherein the control circuit comprises a supercapacitor, the control circuit being configured to cause the closing of the first solenoid valve using energy stored in the supercapacitor when a battery voltage at the first base connector drops below a predetermined threshold.

40. The base of claim 37, further comprising a flow switch coupled to a first water tube that is coupled to the second fitting, the flow switch configured to sense a flow of water through the first water tube, wherein the control circuit is configured to transition from a low-power state to an active state based on an output of the flow switch.

41. The base of claim 37, further comprising a printed circuit board (PCB) that comprises the control circuit, wherein the PCB comprises a plurality of electrical connectors facing in a same direction, wherein the plurality of electrical connectors is configured to be electrically coupled to the first solenoid valve, the first base connector, and to a first sensor of the base.

42. The base of claim 31, further comprising:
a base second valve configured to be coupled to a magazine first valve of the magazine;
a base third valve configured to be coupled to a magazine second valve of the magazine, the base third valve coupled to the base second valve via a first water tube; and
a base fourth valve configured to be coupled to a magazine third valve of the magazine, wherein the base fourth valve is coupled to the second fitting via a second water tube.

43. The base of claim 42, wherein the base input water valve, the base first valve, the base second valve, the base third valve, and the base fourth valve are poppet valves.

44. The base of claim 31, further comprising a first total dissolved solids (TDS) sensor coupled to a first water tube that is coupled between the first fitting and the base input water valve, wherein the first TDS sensor is configured to sense a quality of water flowing through the first water tube.

45. The base of claim 44, wherein the base further comprises a control circuit configured to receive sensor data from the first TDS sensor, the control circuit comprising a communication interface circuit, wherein the control circuit is configured to transmit information based on the sensor data using the communication interface circuit.

46. The base of claim 45, wherein the control circuit is configured to transmit the information using the communication interface circuit in a wireless manner.

47. The base of claim 31, wherein the base does not comprise a battery or a battery receptacle and wherein the base is configured to be electrically disconnected from mains.

48. A method for operating a water filtration system, the method comprising:
receiving input water at a first fitting;
providing drinking water at a second fitting, the drinking water having less impurities than the input water;
transitioning a first switch from a first state to a second state;
in response to the first switch transitioning from the first state to the second state, closing a first solenoid valve having a water path coupled to the first fitting, the first solenoid valve being inside a housing of the water filtration system;
after closing the first solenoid valve, replacing a water filter of the water filtration system without turning off the input water; and
after replacing the water filter, opening the first solenoid valve.

49. The method of claim 48, further comprising, in response to the first switch transitioning from the first state to the second state, closing a second solenoid valve having a water path coupled to a third fitting that is coupled to a water storage tank, the second solenoid valve being inside the housing of the water filtration system.

50. The method of claim 48, further comprising:
in response to the first switch transitioning from the first state to the second state, detaching a magazine of the water filtration system from a base of the water filtration system, wherein the magazine comprises the water filter, and wherein the base comprises the first solenoid valve and the first and second fittings; and
after replacing the water filter and before opening the first solenoid valve, attaching the magazine to the base.

51. The method of claim 50, wherein the first switch comprises a lever attached to the base, and wherein transitioning the first switch from the first state to the second state comprises transitioning the lever from a first position to a second position.

52. The method of claim 50, further comprising, after detaching the magazine from the base and before replacing the water filter, detaching a lid from the magazine to expose the water filter.

53. The method of claim 52, wherein detaching the lid exposes a battery of the magazine, the method further comprising, after detaching the lid, replacing the battery.

54. The method of claim 50, further comprising, after detaching the magazine from the base, preventing water stored in the magazine from leaking from the magazine by using a poppet valve.

55. The method of claim 50, further comprising, after detaching the magazine from the base, preventing water stored in the base from leaking leakage from the base using a poppet valve.

56. A method for preventing water leakage from a water filtration system, the method comprising:
receiving input water at a first fitting of a base of the water filtration system;
providing drinking water at a second fitting of the base, the drinking water having less impurities than the input water;
transitioning a first switch from a first state to a second state to detach a magazine from the base, the magazine comprising a water filter that receives the input water from the base and provides filter water to the base, the drinking water being based on the filtered water; and
in response to the first switch transitioning from the first state to the second state, closing a first solenoid valve having a water path coupled to the first fitting or to the second fitting, the first solenoid valve being inside a housing of the base.

57. The method of claim 56, wherein:
receiving the input water with the magazine from the base comprises receiving the input water using a first poppet valve pair comprising a first base poppet valve located in the base and a first magazine poppet valve located in the magazine and aligned with the first base poppet valve so as to allow water flow from the base to the magazine when the magazine is attached to the base and prevent water flow out of the base and out of the magazine when the magazine is detected from the base; and
providing filtered water from the magazine to the base comprises providing filtered water using a second poppet valve pair comprising a second base poppet valve located in the base and a second magazine poppet valve located in the magazine and aligned with the second base poppet valve so as to allow water flow from the magazine to the base when the magazine is attached to the base and prevent water flow out of the base and out of the magazine when the magazine is detected from the base.

58. The method of claim 56, further comprising:
receiving power from a power source;
determining whether the power source is disconnected from the water filtration system; and
in response to determining that the power source is disconnected from the water filtration system, closing the first solenoid valve using energy stored in a supercapacitor.

59. The method of claim 58, wherein the power source is a battery.

60. The method of claim 56, further comprising:
receiving power from a battery;
determining a voltage of the battery; and
when the voltage of the battery is below a predetermined threshold, closing the first solenoid valve.

61. A method for preserving power in a water filtration system, the method comprising:
receiving input water at a first fitting;
providing drinking water at a second fitting, the drinking water having less impurities than the input water;
when the water filtration system is in an active state, sensing a quality of water inside the water filtration system using a sensor to produce sensor data, collecting the sensor data using a control circuit, and transmitting information based on the sense data using a communication interface circuit of the control circuit;
when the water filtration system in in a low-power state, turning off or into a low power state the communication interface circuit, wherein the water filtration system is powered from a battery, wherein an active power consumption from the battery during the active state is higher than a low-power power consumption from the battery during the low-power state;
detecting water flow out of the second fitting using a flow switch;
when water is not flowing out of the second fitting, entering the low-power state; and
when water begins to flow out of the second fitting, transition from the low-power state to the active state.

62. The method of claim 61, wherein the water filtration system comprises a base that comprises the control circuit, the first and second fittings, and the flow switch, and a magazine that is detachable from the base, the magazine comprising a water filter and the battery.

63. The method of claim 61, further comprising:
providing power to the sensor during the active state; and
not providing power to the sensor during the low-power state.

64. The method of claim 63, wherein the sensor is a first total dissolved solids (TDS) sensor.
